(19) United States
(12) Patent Application Publication
(10) Pub. No.: US 2026/0118218 A1
(43) Pub. Date: Apr. 30, 2026

(54) WEAR DETECTION DEVICE

(71) Applicant: NK Photonics Ltd., Taipei (TW)

(72) Inventors: Nan-Kuang CHEN, Taipei (TW); Si-Chi CHEN, Taipei (TW); Hsuan-Yu CHEN, Taipei (TW); LI-YING TSAO, Taipei (TW)

(73) Assignee: NK Photonics Ltd., Taipei (TW)

(21) Appl. No.: 19/193,796

(22) Filed: Apr. 29, 2025

(30) Foreign Application Priority Data
Oct. 31, 2024 (CN) 202411546449.8

(51) Int. Cl. G01M 13/04; G01D 5/252

(52) U.S. Cl. CPC G01M 13/04; G01D 5/252

(57) ABSTRACT

Provided is a wear detection and displacement device, belonging to the technical field of equipment wear and displacement detection. The technical problem to be solved is how to accurately locate the exact position and damage situation of wearing for the working mechanical equipment, thus improving operating efficiency of the mechanical equipment. An adopted technical solution is as follows: the wear and displacement detection device includes a unidirectional push-forward mechanical structure, one end of which is provided with a non-conducting cutter, and flexible printed circuits (FPCs) are arranged below the non-conducting cutter, and the FPCs are electrically connected to a circuit board. Cutoff signals of the FPCs are obtained through the circuit board, thus obtaining a relative displacement of internal components, upon which a wear condition and wear speed of a mechanical structure are calculated.

### CROSS-REFERENCE TO RELATED APPLICATION

This patent application claims the benefit and priority of Chinese Patent Application No. 202411546449.8 filed with the China National Intellectual Property Administration on Oct. 31, 2024, the disclosure of which is incorporated by reference herein in its entirety as part of the present application.

### TECHNICAL FIELD

The present disclosure relates to the technical field of equipment wear detection, and in particular to a wear detection device.

### BACKGROUND

The operating end of existing mechanical equipment (such as a shield machine, a drilling rig, crawler construction machinery, a rotary drilling rig) often suffers from serious wear and bolt loosing or dropping caused by vibration during operation, and accidents will be caused if the wear cannot be found, resulting unnecessary losses.

For example, the main component of the shield machine is a cutter head, and the wear of cutter head will directly affect the normal operation of the shield machine. At present, high-pressure oil pipe is generally used to detect the wear of the cutter head of the shield machine, and its tail with a metal end-cap is exposed to the surface of the cutter head. When the pipe is worn to be broken, the oil pressure drops sharply, but this method is inaccurate and easy to cause pollution and the wear speed cannot be obtained by the method. In addition, the wear sensor based on resistors is also used to detect the wear of the cutter head and the scraper, but this kind of the wear sensor is easy to be affected by the external acoustic vibrations and temperature variations, leading to inaccurate measurement. Other mechanical components of the shield machine will also, more or less, be worn in the process of use, but at present, the current technology is not able to provide in-situ and in-time monitoring and cautious warning toward the wearing condition of the mechanical components of the shield machine (such as a hob). Furthermore, the bolts for fixing hob of the cutter head of the shield machine or the bolts inside the coal miner are often loosened due to severe vibrations during operation, which are difficult to be observed and cannot be detected with current technologies.

Therefore, how to accurately locate the exact position, detect the wear speed and warn bolt loosing or dropping, as well as the real-time damage situation of the wearing in the mechanical equipment to improve the operation efficiency is the technical problem to be solved urgently at present.

### SUMMARY

The technical task of the present disclosure is to provide a wear and displacement detection device to solve the problem of how to accurately locate the exact position and damage situation of the wearing for the working mechanical equipment, thereby improving the operation efficiency of the mechanical equipment.

The technical solution of the present disclosure is implemented as follows: a wear detection and displacement device includes a unidirectional push-forward mechanical structure. One end of the unidirectional push-forward mechanical structure is provided with a non-conducting cutter, flexible printed circuits (FPCs) or flexible flat circuits (FFCs) are arranged below the non-conducting cutter, and the FPCs are electrically connected to a circuit board. Cutoff signals of the FPCs are obtained through the circuit board when the individual FPCs are cut in order, thus obtaining a wear condition and a wear speed of a mechanical structure based on a displacement amount.

In one embodiment, the unidirectional push-forward mechanical structure includes an outer sleeve, and a signal emitting unit. A baffle is arranged at a lower-middle position of the outer sleeve, an inner sleeve is arranged at an upper portion of the outer sleeve, and the inner sleeve is located above the baffle. A guide pillar is arranged on an inner side of an upper side surface of the outer sleeve, and in match with an outer wall of the inner sleeve to achieve limiting.

A boss is arranged at a middle position of an upper end surface of the inner sleeve, one end of the boss is located outside the outer sleeve, the non-conducting cutter is arranged at the other end of the boss, and one end of the non-conducting cutter is mounted at a middle position of the boss. The FPCs are arranged at the other end of the non-conducting cutter, the circuit board is mounted on the baffle, and a power supply unit is arranged below the baffle, and configured to supply power to the circuit board.

The circuit board is electrically connected to the signal emitting unit, and the signal emitting unit is configured to convert an electric signal into a wireless signal or an optical signal and transmit the optical signal via an optical fiber.

In one embodiment, one side, close to the outer wall of the inner sleeve, of the guide pillar is provided with limiting teeth, the outer wall of the inner sleeve is provided with barb teeth, and the barb teeth are meshed with the limiting teeth to achieve the purpose of limiting.

In one embodiment, one side of the circuit board is provided with a conductive communicating slot.

A conductive rod is arranged in the inner sleeve, one end of the conductive rod is fixedly connected to the inner sleeve, and the other end of the conductive rod is in match with the conductive communicating slot. That is, in an initial state, the conductive rod is located above the circuit board, and gradually enters the conductive communicating slot with the downward movement of the conductive rod.

In one embodiment, the other end of the non-conducting cutter is provided with multiple rows of metal tubes, and both ends of the metal tubes are connected to wires on both sides of the metal tubes, respectively.

In one embodiment, the circuit board includes a parallel-in-to-serial-out chip I, a parallel-in-to-serial-out chip II, a resistor R1, a resistor R2, a resistor R3, a resistor R4, a resistor R5, a resistor R6, a resistor R7, a resistor R8, an electric wire group E1, an electric wire group E2, an electric wire group E3, an electric wire group E4, an electric wire group E5, an electric wire group E6, an electric wire group E7, and an electric wire group E8. A pin D0 on the parallel-in-to-serial-out chip I is electrically connected to the resistor R1, a pin D1 on the parallel-in-to-serial-out chip I is electrically connected to the resistor R2, a pin D2 on the parallel-in-to-serial-out chip I is electrically connected to the resistor R3, a pin D3 on the parallel-in-to-serial-out chip I is electrically connected to the resistor R4, a pin D4 on the parallel-in-to-serial-out chip I is electrically connected to the resistor R5, a pin D5 on the parallel-in-to-serial-out chip I is electrically connected to the resistor R6, a pin D6 on the parallel-in-to-serial-out chip I is electrically connected to the resistor R7, and a pin D7 on the parallel-in-to-serial-out chip I is electrically connected to the resistor R8. The resistors R1, R2, R3, R4, R5, R6, R7 and R8 are electrically connected to the electric wire groups E1, E2, E3, E4, E5, E6, E7 and E8 through the FPCs, respectively.

A pin D0 on the parallel-in-to-serial-out chip II is electrically connected to the electric wire group E1, a pin D1 on the parallel-in-to-serial-out chip II is electrically connected to the electric wire group E2, a pin D2 on the parallel-in-to-serial-out chip II is electrically connected to the electric wire group E3, a pin D3 on the parallel-in-to-serial-out chip II is electrically connected to the electric wire group E4, a pin D4 on the parallel-in-to-serial-out chip II is electrically connected to the electric wire group E5, a pin D5 on the parallel-in-to-serial-out chip II is electrically connected to the electric wire group E6, a pin D6 on the parallel-in-to-serial-out chip II is electrically connected to the electric wire group E7, a pin D7 on the parallel-in-to-serial-out chip II is electrically connected to the electric wire group E8, and a pin Q7 on the parallel-in-to-serial-out chip II is electrically connected to a pin DS on the parallel-in-to-serial-out chip I.

In one embodiment, a flip-flop is arranged at the lowermost FPC to each of the electric wire groups E2, E3, E4, E5, E6, E7 and E8. The electric wire group E1 is electrically connected to the conductive rod; and the electric wire groups E2, E3, E4, E5, E6, E7 and E8 are connected to the conductive rod through the flip-flops, respectively.

In one embodiment, diodes are arranged at connections of the electric wire groups E2, E3, E4, E5, E6, E7 and E8 with the resistors R1, R2, R3, R4, R5, R6, R7 and R8.

In one embodiment, the circuit board further includes a microprocessor control unit (MCU), and a display screen. The MCU is electrically connected to the parallel-in-to-serial-out chip I and the display screen, and configured to acquire data on the parallel-in-to-serial-out chip I. The display screen is configured to display the data acquired by the MCU.

In one embodiment, a pulse generator is electrically connected to the parallel-in-to-serial-out chip I.

In one embodiment, an operation principle of the circuit board is as follows:

When the conductive rod is in contact with a circuit switch, a circuit is started and become conducting, the electric wire group E1 is powered on, the circuits comprising the resistors R1, R2, R3, R4, R5, R6, R7 and R8 are all switched on so that the voltages are identified and recorded as a high level by a parallel-to-serial chip I; when the FPCs are cut off, the voltage of the circuits in front of the conducted circuit turns out to become a low level.

When an eighth circuit to the electric wire group E1 is cut off, a falling edge-triggered flip-flop is started to operate, the electric wire group E2 is switched on, and eight resistors, i.e., the resistors R1, R2, R3, R4, R5, R6, R7 and R8 connected to the electric wire group E1 are reused, an operation principle of the cutting off the FPCs is the same as that of the electric wire group E1. In this case, the electric wire groups E1 and E2 are both at a high level at the upstream of the FPCs, but at the downstream of the FPCs, the electric wire group E1 is at the low level, the electric wire group E2 is at a low level in a disconnected area, and remained at a high level in an unbroken area. The electric wire groups E3, E4 and E5 are not switched on, and thus all are at the low level. When an eighth FPC to the electric wire group E2 is cut off, the electric wire group E3 is started to be powered on.

The high-low level states of the electric wire groups E1, E2, E3, E4, E5, E6, E7 and E8 at upstream are transmitted to a parallel-to-serial chip II, and then a serial signal is merged into the parallel-to-serial chip I, the merged signal pulse train has a total of 16 bits, in which the first eight bits indicate on/off state for the eight individual circuit belonging to a certain electric wire group, and the other eight bits are on-off states of the electric wire groups E1, E2, E3, E4 and E5, the exact number of cut-off circuits is calculated and the displacement amount of the non-conducting cutter is obtained based on the merged serial signal at present, and then a remaining accurate distance of the non-conducting cutter relative to a wear critical point and a wear speed of the non-conducting cutter are calculated.

A signal output by the parallel-to-serial chip I is processed by the MCU, and then transmitted to the display screen for display, or be directly transmitted out by a wireless signal transmitter, or directly drive a laser source or a light-emitting diode to be directly transmitted to a central control system via an optical fiber for display.

In one embodiment, the unidirectional push-forward mechanical structure includes a sleeve. The circuit board is arranged at one end of the sleeve, and the other end of the sleeve is provided with a push rod base. One end of the push rod base is provided with a push rod, and the non-conducting cutter is arranged at the other end of the push rod base. A fixing groove is formed in an inner side of the sleeve, the non-conducting cutter is located at one end of the fixing groove, and the FPCs are arranged at the other end of the fixing groove. The FPCs are electrically connected to the circuit board and located on a moving path of a cutting edge of the non-conducting cutter, and a side wall of the sleeve is in match with the push rod base through a limiting mechanism.

In one embodiment, the limiting mechanism includes multiple groups of spring pins, and multiple groups of oblique dentations corresponding to the spring pins. Each group of spring pins is arranged on the side wall of the sleeve in an axial direction, and each group of oblique dentations are arranged on an outer side wall of the push rod base in an axial direction. The spring pin is in match with the oblique dentation in a clamping manner, that is, when the oblique dentation passes through the spring pin, the spring pin bounces up, and after passing through the spring spin, the spring pin is reset to catch the oblique dentation.

In one embodiment, the limiting mechanism includes serrated teeth, and corrugated strips arranged in one-to-one correspondence with the serrated teeth. Multiple groups of serrated teeth are provided, which are circumferentially distributed on an inner side wall of the sleeve. Each group of serrated teeth is arranged on the side wall of the sleeve in an axial direction, and adjacent groups of serrated teeth are staggered according to a set phase difference. Each group of corrugated strips is arranged on the outer side wall of the push rod base in an axial direction, and the serrated teeth are clamped with the corrugated strips.

In one embodiment, the FPCs are electric wires arranged at a specific period (i.e. pitch), and the FPCs satisfy a phase-matching condition with an effective period of the limiting mechanism, where the effective period is equal to an actual displacement of whole multiple groups of serrated teeth upon traveling one step or experiencing a meshing.

In one embodiment, the circuit board includes a parallel-in-to-serial-out chip, an electric wire group E1, an electric wire group E2, an electric wire group E3, an electric wire group E4, an electric wire group E5, an electric wire group E6, an electric wire group E7 . . . , and an electric wire group En. Pins D0, D1, D2, D3, D4, D5, D6 and D7 of the parallel-in-to-serial-out chip are electrically connected to the electric wire groups E1, E2, E3, E4, E5, E6, E7 . . . , and En through the FPCs, respectively. The pin D7 is electrically connected to the downstream of a cutting breakpoint at the lowermost FPC to respective electric wire groups through respective diodes.

In one embodiment, a flip-flop is electrically connected to the downstream of the cutting breakpoint of the FPC at the lowermost FPC to each of the electric wire groups E2, E3, E4, E5, E6, E7 . . . , and En. The electric wire group E1 is electrically connected to a conductive rod. The electric wire groups E2, E3, E4, E5, E6, E7 and En are connected to a power supply through the flip-flops and the diodes, respectively.

The circuit board further includes an MCU, or a counter. The MCU or the counter is electrically connected to the parallel-in-to-serial-out chip, and the parallel-in-to-serial-out chip is electrically connected to a pulse generator.

In one embodiment, each of the pins D0, D1, D2, D3, D4, D5, D6 and D7 of the parallel-in-to-serial-out chip is electrically connected to a pull-down resistor. One end of each pull-down resistor is electrically connected to corresponding one of the pins D0, D1, D2, D3, D4, D5, D6 and D7 of the parallel-in-to-serial-out chip, and the other end of each pull-down resistor is grounded.

In one embodiment, an operation principle of the circuit board is as follows:

When the conductive rod is in contact with a circuit switch, a circuit is started and become conducting, the electric wire group E1 is powered on, all circuits of the electric wire group E1 are switched on, and recorded to have a high level by the parallel-in-to-serial-out chip. When the FPCs are cut off in sequence, the voltages of the corresponding cut-off circuits turn out to become a low level.

When an eighth circuit of the electric wire group E1 is cut off, a falling edge-triggered flip-flop is started to output the high voltage level, and in this case, the electric wire group E2 is switched on, and eight circuits, which are connected to the parallel-in-to-serial-out chip, of the electric wire group E1 are reused, and an working principle of the cutting off the FPCs is the same as that of the electric wire group E1. In this time, the electric wire groups E1 and E2 are both at a high level at the upstream of a breakpoint of the FPCs, but at the downstream of the breakpoint of the FPCs, the electric wire group E1 is at a low level and does not cause any interference to the pins of the parallel-in-to-serial-out chip, while the electric wire group E2 is at a low level in a disconnected area, and remained at a high level in an unbroken area. The electric wire groups E3 to En are not switched on, and thus are all at the low level and do not cause any interference to the pins of the parallel-in-to-serial-out chip; and when an eighth FPC to the electric wire group E2 is cut off, the electric wire group E3 is started to be powered on.

A pulse signal generated by the pulse generator is injected into the parallel-in-to-serial-out chip to generate 8-bit serial output signal for representing high-low level states of downstream of the corresponding electric wire groups.

The pin D0 of the parallel-in-to-serial-out chip is connected to a count-up counter. When the electric wire group E1 is not powered on, the pin D0 of the parallel-in-to-serial-out chip shows a low level, when a first FPC is switched on and connected to a power supply, the pin D0 of the parallel-in-to-serial-out chip shows a high level, and when the first FPC is cut off, the low level is detected at the pin D0 of the parallel-in-to-serial-out, thus forming a complete pulse consisting of a rising edge signal and a falling edge signal, and the count-up counter is incrementally added by 1; a situation similar to that of the first circuit to the electric wire group E1 is formed from a situation that a first circuit to the second group is not powered on to a situation that the first circuit is cut off, the count-up counter is incrementally added by 1 again; and then similar operation is repeated till the starting of the electric wire group En. Every time a first circuit of the group is switched on and then cut off, and a numerical value of the counter is used to infer that the operation enters an n^{th} electric wire group. After merging the parallel-in-to-serial-out chip and the count-up counter, the detection of sequential on-off states of infinite circuits can be obtained, the number of cut-off circuits is calculated and the displacement amount of the non-conducting cutter is obtained based on the detection at present, and a remaining accurate distance of the non-conducting cutter relative to a wear critical point and a wear speed of the non-conducting cutter are calculated.

Signals output by the parallel-in-to-serial-out chip and the counter are processed by the MCU, and then transmitted to a screen for display, or be directly transmitted out by a wireless signal transmitter, or directly drive a laser source or a light-emitting diode to be directly transmitted to a central control system via an optical fiber for display.

In one embodiment, the circuit board includes a multi-channel sequential power supply signal source, a circuit break trigger, a parallel-in-to-serial-out chip, an electric wire group E1, an electric wire group E2, an electric wire group E3, an electric wire group E4, an electric wire group E5, an electric wire group E6, an electric wire group E7 . . . , and an electric wire group En; pins D0, D1, D2, D3, D4, D5, D6 and D7 of the parallel-in-to-serial-out chip are electrically connected to the electric wire groups E1, E2, E3, E4, E5, E6, E7, . . . , En through the FPCs, respectively.

In one embodiment, a circuit break trigger is electrically connected to the downstream of the cutting breakpoint of the FPCs at the lowermost FPC to each of the electric wire groups E1, E2, E3, E4, E5, E6, E7, . . . , and En through a diode, and a pin T0 of the multi-channel sequential power supply signal source is electrically connected to the circuit break trigger; the electric wire groups E1, E2, E3, E4, E5, E6, E7, . . . , and En are connected to pins T1, T2, T3, T4, T5, T6, T7, . . . , and Tn on the multi-channel sequential power supply signal source through diodes, respectively.

The circuit board further includes an MCU, or a counter. The MCU or the counter is electrically connected to the parallel-in-to-serial-out chip, and the parallel-in-to-serial-out chip is electrically connected to a pulse generator.

In one embodiment, each of the pins D0, D1, D2, D3, D4, D5, D6 and D7 of the parallel-in-to-serial-out chip is electrically connected to a pull-down resistor. One end of each pull-down resistor is electrically connected to corresponding one of the pins D0, D1, D2, D3, D4, D5, D6 and D7 of the parallel-in-to-serial-out chip, and the other end of each pull-down resistor is grounded.

In one embodiment, an operation principle of the circuit board is as follows:

When the multi-channel power supply signal source is started, the pin T1 transmits a high voltage level signal into the electric wire group E1, such that all circuits in the electric wire group E1 are switched on, and a high level is recorded by the parallel-in-to-serial-out chip. When the FPCs are cut off in sequence, the corresponding cut-off circuits are all converted to be at a low level.

When an eighth circuit of the electric wire group E1 is cut off, the circuit break trigger is started to output a pulse signal to a pin T0 of the multi-channel sequential power supply signal source, the output high level signal is switched by the multi-channel sequential power supply signal source to the pin T2, thus switching on the electric wire group E2. Eight circuits, which are connected to the parallel-in-to-serial-out chip, of the electric wire group E1 are reused, and an operation principle of cutting off the FPCs is the same as that of the electric wire group E1. In this time, except for the electric wire group E2, the rest electric wire groups are not switched on, and thus are all at the low level and do not cause any interference to the pins of the parallel-in-to-serial-out chip. When an eighth FPC to the group E2 is cut off, the electric wire group E3 is started to be powered on.

A pulse signal generated by the pulse generator is injected into the parallel-in-to-serial-out chip to generate 8-bit signal pulse train for representing high-low voltage level states of downstream of the corresponding electric wire groups.

The pin D0 of the parallel-in-to-serial-out chip is connected to a count-up counter. When the electric wire group E1 is not powered on, the pin D0 of the parallel-in-to-serial-out chip shows a low level, when a first FPC conducts a high voltage level signal, the pin D0 of the parallel-in-to-serial-out chip shows a high level, and when the first FPC is cut off, the low voltage level is detected at the pin D0 of the parallel-in-to-serial-out, thus forming a complete pulse consisting of a rising edge signal and a falling edge signal and the count-up counter is incrementally added by 1. A situation similar to that of the first circuit to the group E1 is formed from a situation that a first circuit to the second group is not powered on to a situation that the first circuit to the second group is cut off, and the count-up counter is incrementally added by 1 again. And then the similar operation is repeated till to the starting of the group En. Every time the first circuit of the group is switched on and then cut off, and a numerical value of the counter is used to infer that the operation enters an n^{th} electric wire group. After merging the parallel-in-to-serial-out chip and the count-up counter, the detection of sequential on-off states of infinite circuits can be obtained, the number of cut-off circuits is calculated and the displacement amount of the non-conducting cutter is obtained based on the detection at present, and a remaining accurate distance of the non-conducting cutter relative to a wear critical point and a wear speed of the non-conducting cutter are calculated.

Signals output by the parallel-in-to-serial-out chip and the counter are processed by the MCU, and then transmitted to a screen for display, or be directly transmitted out by a wireless signal transmitter, or directly drive a laser source or a light-emitting diode to be directly transmitted to a central control system via an optical fiber for display.

In one embodiment, the wear and displacement detection device includes a non-conducting cutter, flexible printed circuits (FPCs), a circuit board and a limiting mechanism.

The circuit board is mounted on a side surface of a head of a bolt to be detected and another side surface of the head of the bolt is provided with a screw inserted into a threaded hole in a base board.

The FPCs are arranged on the another side surface of the head around the screw in a circumferential direction of the screw, and the FPCs are electrically connected to the circuit board.

The non-conducting cutter is positioned adjacent to the threaded hole and fixed to a side surface of the base board that is provided with the threaded hole, and located on a moving path of the FPCs, the bolt is in match with the base board through the limiting mechanism.

The limiting mechanism includes serrated teeth and corrugated strips arranged in one-to-one correspondence with the serrated teeth. The serrated teeth are arranged on the another side surface of the head around the FPCs in the circumferential direction of the screw and positioned to be further away from the screw than the FPCs in a radial direction of the screw, and the corrugated strips are arranged on side surface of the base board around an opening of the threaded hole in a circumferential direction of the threaded hole, the serrated teeth are meshed with the corrugated strips.

The wear and displacement detection device provided by the present disclosure has the following advantages:
(1) The disclosure adopts the limiting teeth and corresponding inner and outer sleeves, and the adjacent limiting mechanisms, where a set phase difference between the adjacent limiting mechanisms enables an effective actual displacement period less than the period of each limit tooth, thus improving the displacement detection accuracy. When the rock collides with the ejector pin and propel the ejector pin, the limit teeth and the non-conducting cutter are pushed forward to achieve the purpose of accurate locating detection (not affected by the interference, i.e. strong environmental vibration), and the total number of circuits that are broken, i.e. open, in real time and in sequence is calculated, so as to obtain the information of wear locating and issue a warning.
(2) The FPC of the disclosure covers the whole circuit interval and is arranged in parallel with the circuit. The FPC is attached to the inner wall of the outer sleeve by glue, and wiring sockets at both ends of the FPC are embedded into the outer sleeve to avoid affecting the cutter moving forward. A hollow area of the propulsion cutter can accommodate the whole stacked circuit board. The mechanical interval/circuit interval/battery and cable interval can be disassembled or combined with each other, which is convenient for maintenance. When replacing the FPC, the replacement can be achieved only by opening the wiring sockets on both sides. On the inner wall of the outer sleeve and under the FPC, there is a non-conducting cutter traveling guide to avoid the influence of external force on a straight path of the cutter.
(3) The diode is arranged to the front of the electric wire groups E1 to En, which greatly saves space.
(4) With a high-hardness push rod, due to the influence of external high water pressure or earth pressure on the hob underground, a wear-resistant probe is pushed inward quickly by the external pressure, which cannot represent a real metal wear position. A diameter of the probe is reduced and the probe is also used to tighten a hoop of a wear protection sleeve, thereby improving the moving friction, which can greatly reduce the pushing influence of the external pressure on a wear-resistant thin rod.
(5) A resistance spring is arranged in the sleeve to provide a rebound thrust, which may resist a force of the push rod pushed inward by the external pressure.
(6) A way of additional thick and thin racks in parallel for the barb teeth can be adopted, the thick teeth provide a solid structure to block the resistance spring, and the thin teeth provide accurate displacement detection.
(7) The plurality of wear detection devices provided by the present disclosure can be used at the same time, and three-dimensionally superimposed with an included angle, thus achieving multi-angle and multi-dimensional detection.

The present disclosure has the characteristics of reasonable design, simple structure, easy processing, small volume, convenient use, and multiple use of one thing, and thus has good popularization and use value.

### BRIEF DESCRIPTION OF THE DRAWINGS

The present disclosure is further described below with reference to accompanying drawings.

FIG. 1 is a structural schematic diagram of a wear detection device.

FIG. 2 is an assembly schematic diagram of a guide pillar and an inner sleeve.

FIG. 3 is a schematic diagram of a circuit board.

FIG. 4 is a structural schematic diagram of Embodiment 1.

FIG. 5 is a structural schematic diagram of Embodiment 2.

FIG. 6 is a structural schematic diagram of a sleeve.

FIG. 7 is an axial sectional diagram of the sleeve in A-A direction of FIG. 6.

FIG. 8 is a schematic diagram of position relation between serrated teeth and corrugated strip corresponding to the serrated teeth of one embodiment from FIG. 5.

FIG. 9 is an unfolded schematic diagram of the serrated teeth and the corrugated strip FIG. 8.

FIG. 10 is a structural schematic diagram of a circuit board.

FIG. 11 is a structural schematic diagram of a circuit board with an additional pull-down resistor.

FIG. 12 is a structural schematic diagram of a protective sleeve.

FIG. 13 is a structural schematic diagram of an angular displacement and angular speed detection device.

FIG. 14 shows a position relationship among the serrated teeth, a cutter, and FPCs on a bottom surface of a head of a bolt.

In the drawings: 1: outer sleeve; 2: baffle; 3: inner sleeve; 4: guide pillar; 5: boss; 6: non-conducting cutter; 7: flexible printed circuits FPC; 8: circuit board; 9: power supply unit; 10: limiting tooth; 11: barb tooth; 12: conductive communicating slot; 13: conductive rod; 14: sleeve; 15: push rod base; 16: push rod; 17: fixing groove; 18: spring pin; 19: oblique dentation; 20: serrated teeth; 21: corrugated strip; 22: resistance spring; 23: protective sleeve; 24: stepped hole; 25: conical boss; 26: bolt; 27: base board; 28: integrated circuit; 29: wireless transceiver.

### DETAILED DESCRIPTION OF THE EMBODIMENTS

The wear detection device provided by the present disclosure is described in detail below with reference to the accompanying drawings and specific embodiments.

In the description of the present disclosure, it should be understood that the orientation or positional relationship indicated by terms “upper”, “lower”, “front”, “rear”, “left”, “right” , “vertical”, “horizontal”, “top”, “bottom”, “inside” and “outside” is based on the orientation or positional relationship shown in the drawings only for convenience of description of the present disclosure and simplification of description rather than indicating or implying that the device or element referred to must have a particular orientation, be constructed and operated in a particular orientation, and thus are not to be construed as limitation of the disclosure. Furthermore, the terms “first”, “second” and “third” are used for descriptive purposes only and are not to be construed as indicating or implying relative importance.

In the present disclosure, unless expressly specified and limited otherwise, it should be noted that the terms “install”, “connect” and “connection” should be understood broadly, e.g., may be a fixed connection, a detachable connection, or an integrated connection; may be a mechanical connection, or an electrical connection; may be a direct connection, an indirect connection through an intermediate medium, or an internal communication between the two elements. For those of ordinary skill in the art, the specific meanings of the above terms in the utility model can be understood on a case-by-case basis.

### Embodiment 1

This embodiment provides a wear and displacement detection device, including a unidirectional push-forward mechanical structure. One end of the unidirectional push-forward mechanical structure is provided with a non-conducting cutter, flexible printed circuits (FPCs) are arranged below the non-conducting cutter, and the FPCs are electrically connected to a circuit board. Cutoff signals of the FPCs are obtained through the circuit board, thus obtaining a wear condition and wear speed of a mechanical structure.

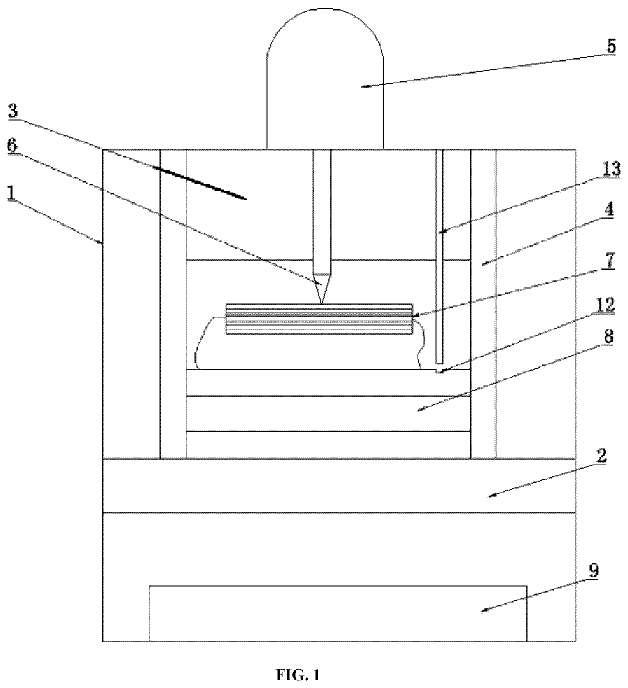

As shown in FIG. 1, the unidirectional push-forward mechanical structure includes an outer sleeve 1, and a signal emitting unit, e.g., laser or LED. A baffle 2 is arranged at a lower-middle position of the outer sleeve 1, an inner sleeve 3 is arranged at an upper portion of the outer sleeve 1, and the inner sleeve 3 is located above the baffle 2. Four uniformly distributed guide pillars 4 are arranged on an inner side of an upper side surface of the outer sleeve 1, and in match with an outer wall of the inner sleeve 3 to achieve limiting. A boss 5 is arranged at a middle position of an upper end surface of the inner sleeve 3. One end of the boss 5 is located outside the outer sleeve 1, a ceramic cutter 6 is mounted at the other end of the boss 5, one end of the ceramic cutter 6 is mounted at a middle position of the boss 5, and the FPCs 7 are mounted at the other end of the ceramic cutter 6. A circuit board 8 is electrically connected to the FPCs 7, and mounted on the baffle 2. A power supply unit 9 is mounted below the baffle 2, and configured to supply power to the circuit board 8.

The circuit board 8 is electrically connected to the signal emitting unit, and the signal emitting unit is configured to convert an electric signal into an optical signal and transmit the optical signal via an optical fiber.

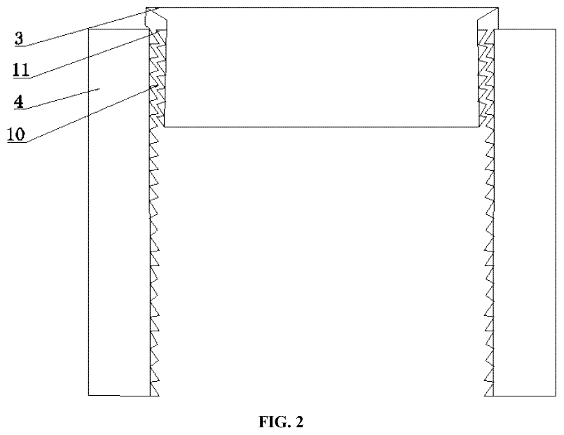

As shown in FIG. 2, in this embodiment, one side, close to the outer wall of the inner sleeve 3, of the guide pillar 4 is provided with limiting teeth 10, the outer wall of the inner sleeve 3 is provided with barb teeth 11, and the barb teeth 11 are meshed with the limiting teeth 10 to achieve the purpose of limiting.

In this embodiment, one side of the circuit board 8 is provided with a conductive communicating slot 12. A conductive rod 13 is mounted in the inner sleeve 3, one end of the conductive rod 13 is fixedly connected to the inner sleeve 3, and the other end of the conductive rod 13 is in match with the conductive communicating slot 12. That is, in an initial state, the conductive rod 13 is located above the circuit board 8, and gradually enters the conductive communicating slot 12 with the downward movement of the conductive rod 13.

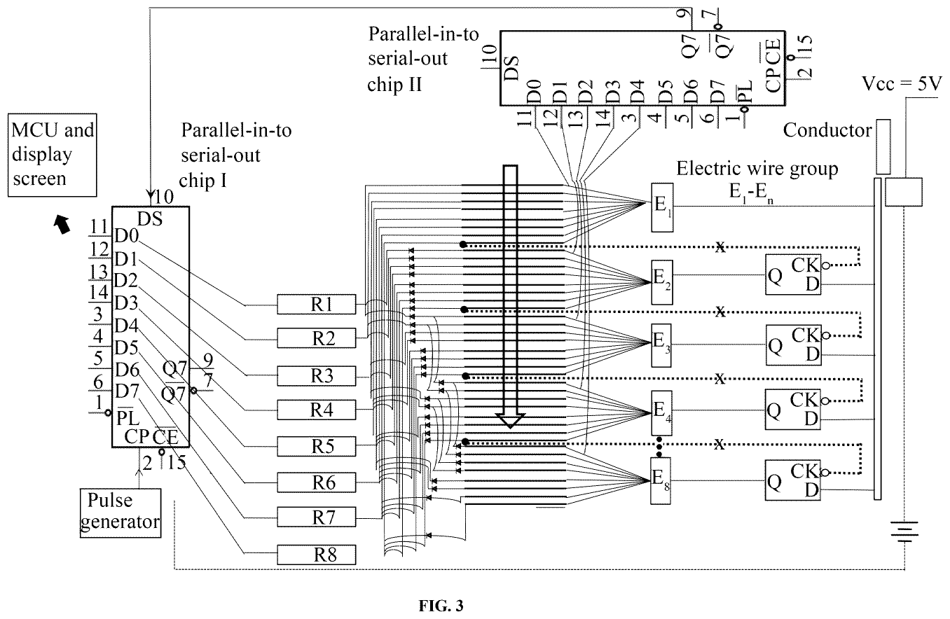

As shown in FIG. 3, in this embodiment, the circuit board 8 includes a parallel-in-to-serial-out chip I, a parallel-in-to-serial-out chip II, a resistor R1, a resistor R2, a resistor R3, a resistor R4, a resistor R5, a resistor R6, a resistor R7, a resistor R8, an electric wire group E1, an electric wire group E2, an electric wire group E3, an electric wire group E4, an electric wire group E5, an electric wire group E6, an electric wire group E7, and an electric wire group E8. A pin D0 on the parallel-in-to-serial-out chip I is electrically connected to the resistor R1, a pin D1 on the parallel-in-to-serial-out chip I is electrically connected to the resistor R2, a pin D2 on the parallel-in-to-serial-out chip I is electrically connected to the resistor R3, a pin D3 on the parallel-in-to-serial-out chip I is electrically connected to the resistor R4, a pin D4 on the parallel-in-to-serial-out chip I is electrically connected to the resistor R5, a pin D5 on the parallel-in-to-serial-out chip I is electrically connected to the resistor R6, a pin D6 on the parallel-in-to-serial-out chip I is electrically connected to the resistor R7, and a pin D7 on the parallel-in-to-serial-out chip I is electrically connected to the resistor R8. The resistors R1, R2, R3, R4, R5, R6, R7 and R8 are electrically connected to the electric wire groups E1, E2, E3, E4, E5, E6, E7 and E8 through the FPCs, respectively.

A pin D0 on the parallel-in-to-serial-out chip II is electrically connected to the electric wire group E1, a pin D1 on the parallel-in-to-serial-out chip II is electrically connected to the electric wire group E2, a pin D2 on the parallel-in-to-serial-out chip II is electrically connected to the electric wire group E3, a pin D3 on the parallel-in-to-serial-out chip II is electrically connected to the electric wire group E4, a pin D4 on the parallel-in-to-serial-out chip II is electrically connected to the electric wire group E5, a pin D5 on the parallel-in-to-serial-out chip II is electrically connected to the electric wire group E6, a pin D6 on the parallel-in-to-serial-out chip II is electrically connected to the electric wire group E7, a pin D7 on the parallel-in-to-serial-out chip II is electrically connected to the electric wire group E8, and a pin Q7 on the parallel-in-to-serial-out chip II is electrically connected to a pin DS on the parallel-in-to-serial-out chip I.

A flip-flop is arranged at the lowermost FPC to each of the electric wire groups E2, E3, E4, E5, E6, E7 and E8. The electric wire group E1 is electrically connected to the conductive rod. The electric wire groups E2, E3, E4, E5, E6, E7 and E8 are connected to the conductive rods through the flip-flops, respectively.

In this embodiment, diodes are arranged at connections of the electric wire groups E2, E3, E4, E5, E6, E7 and E8 with the resistors R1, R2, R3, R4, R5, R6, R7 and R8 to prevent backflow.

In this embodiment, the circuit board 8 further includes a microprocessor control unit (MCU) such as blue tooth MCU or single-chip microcomputer, and a display screen. The MCU is electrically connected to the parallel-in-to-serial-out chip I and the display screen, respectively, and configured to acquire data on the parallel-in-to-serial-out chip I. The display screen is configured to display the data acquired by the MCU.

In this embodiment, a pulse generator is electrically connected to the parallel-in-to-serial-out chip I, and configured to drive the parallel-in-to-serial-out chip I to operate.

In this embodiment, an operating principle of the circuit board 8 is specifically as follows:
when the conductive rod is in contact with a circuit switch, a circuit is started and become conducting, the electric wire group E1 is powered on, the circuits comprising the resistors R1, R2, R3, R4, R5, R6, R7 and R8 are all switched on so that the voltages are identified and recorded as a high level by the parallel-to-serial chip I. When the FPCs are cut off, the voltages of the circuits in front of the conducted circuit turn out to become a low level. For example, if a third circuit is disconnected, the first circuit to the third circuit turn out to become the low level, and a fourth circuit to an eighth circuit are at a high level.

When an eighth circuit to the electric wire group E1 is cut off, a falling edge-triggered flip-flop is started to operate. In this case, the electric wire group E2 is switched on, and eight resistors, i.e., the resistors R1, R2, R3, R4, R5, R6, R7 and R8, for the electric wire group E1 are reused, and an operation principle of cutting off the FPCs is the same as that for the electric wire group E1. In this case, the electric wire groups E1 and E2 are both at a high level at the upstream of the FPCs, but at the downstream of the FPCs, the electric wire group E1 is at a low level, and the electric wire group E2 is at a low level in a disconnected area, and remained at a high level in an unbroken area. The electric wire groups E3, E4 and E5 are not switched on, and thus are both at the low level. When an eighth FPC to the electric wire group E2 is cut off, the electric wire group E3 is started to be powered on.

The level states of the electric wire groups E1, E2, E3, E4, E5, E6, E7 and E8 at the upstream are transmitted to the parallel-to-serial chip II, and then a serial signal is merged into the parallel-to-serial chip I, such that a merged signal pulse train has a total of 16 bits, in which the first eight bits indicate on/off state for the eight individual circuit belonging to a certain electric wire group, and the last eight bits indicate on-off states of the electric wire groups E1, E2, E3, E4 and E5, so as to compute how many circuits are cut off and obtain the displacement amount of the non-conducting cutter at present, and then calculate a remaining accurate distance of the non-conducting cutter relative to the wear critical point and a wear speed of the non-conducting cutter.

A signal output by the parallel-to-serial chip I is processed by the MCU, and then transmitted to the display screen for display, or directly drive a laser source or a light-emitting diode to be directly transmitted to a central control system via an optical fiber for display.

The parallel-to-serial chip I and the parallel-to-serial chip II employ 74HC165 or 74LV165D.

In this circuit board, sequential electronic signals (on/off state of the FPC+electric wire group) are configured to drive and modulate the intensity of a light source, and transmitted through the optical fiber. For example, (0000111111100000) represents that R1=R2=R3=R4=0 which has a low potential or is not switched on, R₅=R₆=R₇=R₈=1 (high potential) and E₁=E₂=E₃=1 (high potential), E₄=E₅=E₆=E₇=E₈=0 (low potential), meaning that the fifth resistor to the third group is powered on at the present. That is, the resistance circuits numbered 1-20 have been cut off, and each FPC accounts for 0.5 mm in width. Therefore, a blade has cut into the current system by 0.5 mm*20=10 mm, which means that the non-conducting cutter has entered with a displacement amount of 10 mm in depth direction upon calculating from a zero point. If a wear warning point of a cutter head and a scraper is located at a position where the 30^{th} FPC wire is cut off, the current distance from the wear warning point is 5 mm. When the wear detection device is used for detecting the sedimentation state of the coal mine roof, in the same case as above, a relative displacement of 10 mm has been occurred between the reference point (i.e. the last FPC) and the measurement point (i.e. the cutter position). The speed at which the FPC is cut off in order can also be calculated using measuring time difference between the FPCs being cut off, thus obtaining a wear speed.

### Embodiment 2

The only difference between this embodiment and Embodiment 1 is that the other end of the non-conducting cutter is provided with a plurality of rows of metal tubes, and both ends of the metal tubes are connected to wires on both sides of the metal tubes, respectively. Other structures, connection relationships and positional relationships are the same as those in Embodiment 1.

The metal tube is a hollow metal tube with a diameter of 0.38 mm. The multiple hollow metal tubes, which are close to each other with tiny gaps therebetween, are arranged neatly and then fixed to a substrate (such as a plastic or metal buckle). After a cutter descends, the hollow metal tubes are separated by touching, resulting in the circuits to be broken, thereby determining the wearing point of the cutter head and scraper. The dropped metal tube(s) can be collected and fixed back to the plastic buckle for use, which is more environmentally friendly. The metal buckle for fixing the hollow metal tube may refer to a metal fixing clamp seat of the traditional fuse.

### Embodiment 3

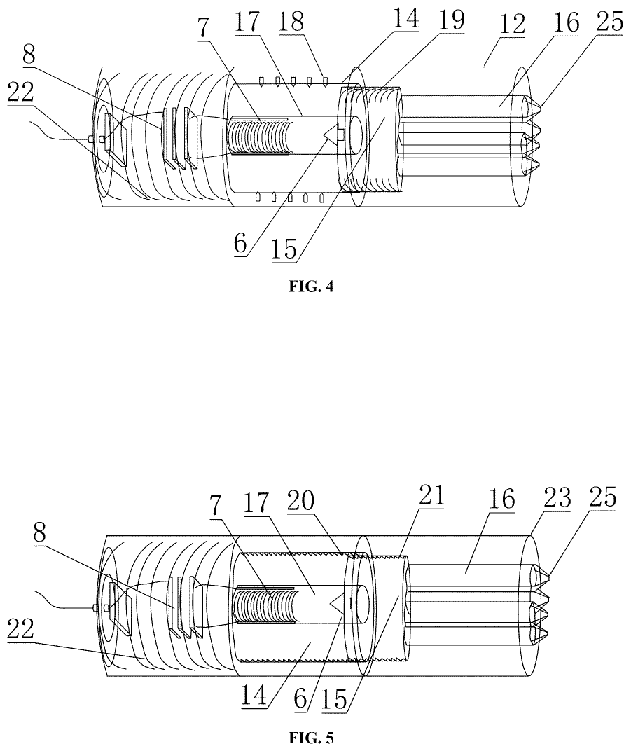

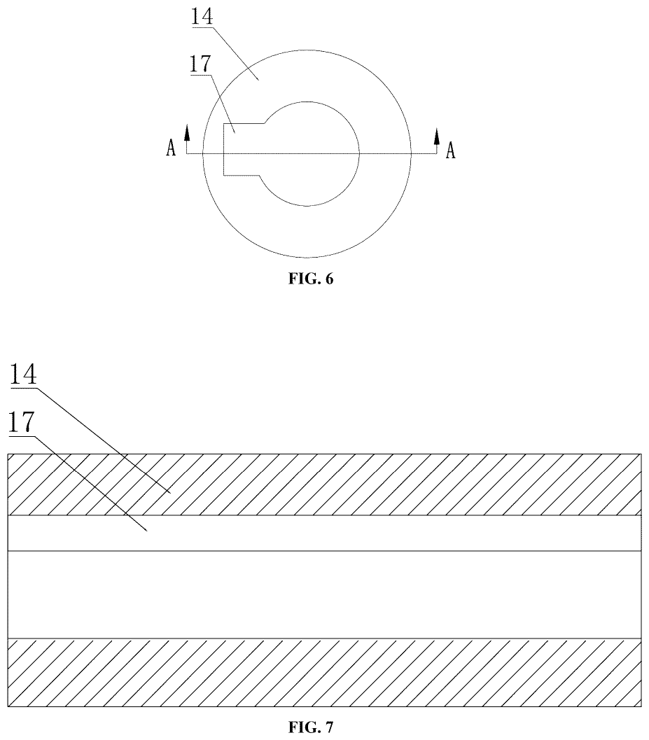

As shown in FIG. 4, FIG. 6 and FIG. 7, the unidirectional push-forward mechanical structure includes a sleeve 14. The circuit board 8 is arranged at one end of the sleeve 14, the other end of the sleeve 14 is provided with a push rod base 15, one end of the push rod base 15 is provided with a push rod 16, and the non-conducting cutter 6 is mounted at the other end of the push rod base 15. A fixing groove 17 is formed in an inner side of the sleeve 14, the non-conducting cutter 6 is located at one end of the fixing groove 17, and the FPCs 7 are arranged at the other end of the fixing groove 17. The FPCs 7 are electrically connected to the circuit board 8 and located below a cutting edge of the non-conducting cutter 6, and a side wall of the sleeve 14 is in match with the push rod base 15 through a limiting mechanism.

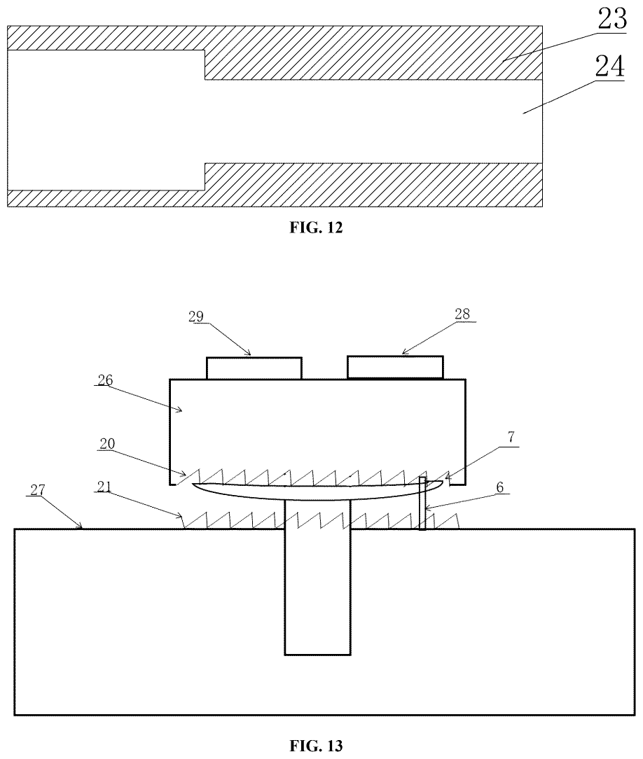

In this embodiment, the limiting mechanism includes multiple groups of spring pins 18, and multiple groups of oblique dentations 19 corresponding to the spring pins. Each group of spring pins 18 is arranged on a side wall of the sleeve 14 in an axial direction, and each group of oblique dentations 19 are arranged on an outer side wall of the push rod base 15 in an axial direction. The spring pin 18 is clamped with the oblique dentation 19, that is, when the oblique dentation 19 passes through the spring pin 18, the spring pin 18 bounces up, the spring pin 18 is reset to catch the oblique dentation 19. One end, away from the FPCs 7, of the sleeve 14 is provided with a resistance spring 22, and the resistance spring 22 is configured to assist in supporting the push rod 16 and prevent the push rod 16 from being easily pushed into the sleeve 14. The push rod 16 is sleeved with a protective sleeve 23, and a stepped hole 24 is formed in the protective sleeve 23, as shown in FIG. 12. The push rod base 15 and the push rod 16 are correspondingly mounted in the stepped hole 24 of the protective sleeve 23, and the stepped hole 24 of the protective sleeve 23 is in interference fit with the push rod 16 and the push rod base 15. One end of the push rod 16 is fixedly connected to the push rod base 15, and the other end of the push rod 16 is provided with a conical boss 25. An outer end face of the conical boss 25 is flush with an end face, away from the sleeve 14, of the protective sleeve 23.

The FPCs 7 are electric wires arranged at a specific period (i.e. pitch), and the FPCs satisfy a phase-matching condition with an effective period of the limiting mechanism, where the effective period is equal to an actual displacement period jointly formed by multiple groups of grooves arranged in a staggered manner.

### Embodiment 4

The only difference between this embodiment and Embodiment 3 is that, as shown in FIG. 5, the limiting mechanism includes serrated teeth 20, and corrugated strips 21 arranged in one-to-one correspondence with the serrated teeth. Multiple groups of serrated teeth 20 are provided, which are circumferentially distributed on an inner side wall of the sleeve 14. Each group of serrated teeth 20 is arranged on the side wall of the sleeve 14 in an axial direction, and adjacent groups of serrated teeth 20 are staggered according to a set phase difference. Each group of corrugated strips 21 is arranged on the outer side wall of the push rod base 15 in an axial direction, and the serrated teeth 20 are clamped with the corrugated strips 21. Other structures, connection relationships and position relationships are the same as those in Embodiment 1.

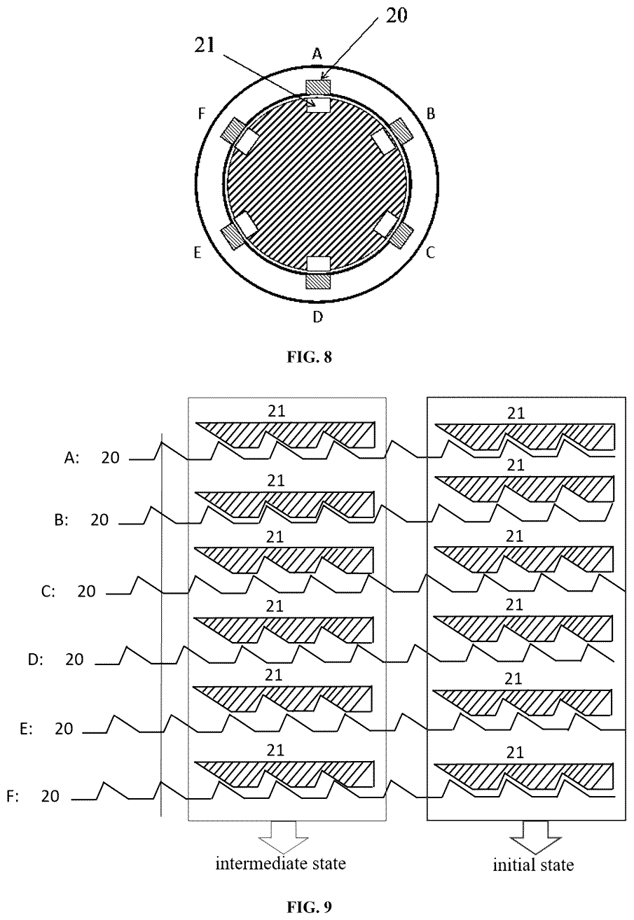

The FPCs 7 are electric wires arranged at a specific period (i.e. pitch), and the FPCs satisfy a phase-matching condition with an effective period of the limiting mechanism, where the effective period is equal to an actual displacement of whole multiple groups of serrated teeth upon traveling one step or experiencing one meshing. In one embodiment, six serrated tooth groups A-F are arranged on the side wall of the sleeve in the circumferential direction and spaced apart from each other at the interval, each serrated tooth group is formed like a gear rack. Six corresponding corrugated strips 21 are arranged on the outer side wall of the push rod base in the circumferential direction, as shown in FIG. 8.

FIG. 9 is an unfolded schematic diagram of the serrated tooth groups and the corrugated strips of FIG. 8. All serrated tooth group are the same, except that they are arranged in a staggered manner with respect to each other at an interval of T/5 in an axial direction, where T denotes an period of the serrated tooth group, which refers to a distance from a point of one tooth in any serrated tooth group to the next one tooth at the same point in the axial direction. As shown in FIG. 9, the serrated tooth group A is staggered with respect to the serrated tooth group B at the interval of T/5, the serrated tooth group B is staggered with respect to the serrated tooth group C at an interval of T/5, the serrated tooth group C is staggered with respect to the serrated tooth group D at an interval of T/5, the serrated tooth group D is staggered with respect to the serrated tooth group E at an interval of T/5. In this case, the effective period of the six serrated tooth groups is T/5. At the initial state, the serrated tooth group A and the serrated tooth group F mesh with the corrugated strip group A and the corrugated strip group F, respectively. As the cutter is moving forward for an interval of 4T+T/5, the serrated tooth group B meshes with the corrugated strip group B whereas the rest of the serrated tooth groups do not mesh with their corresponding the corrugated strip groups.

### Embodiment 5

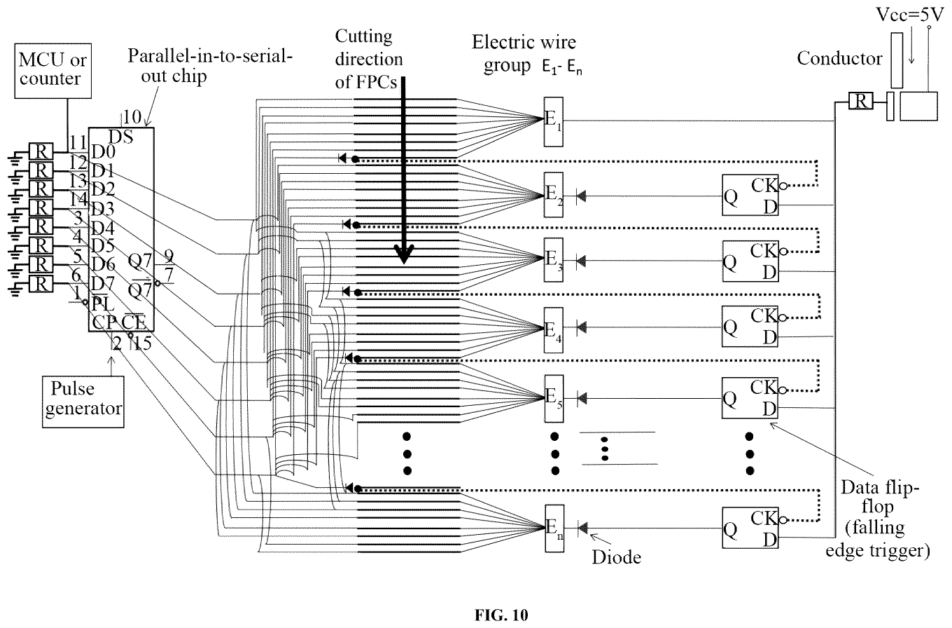

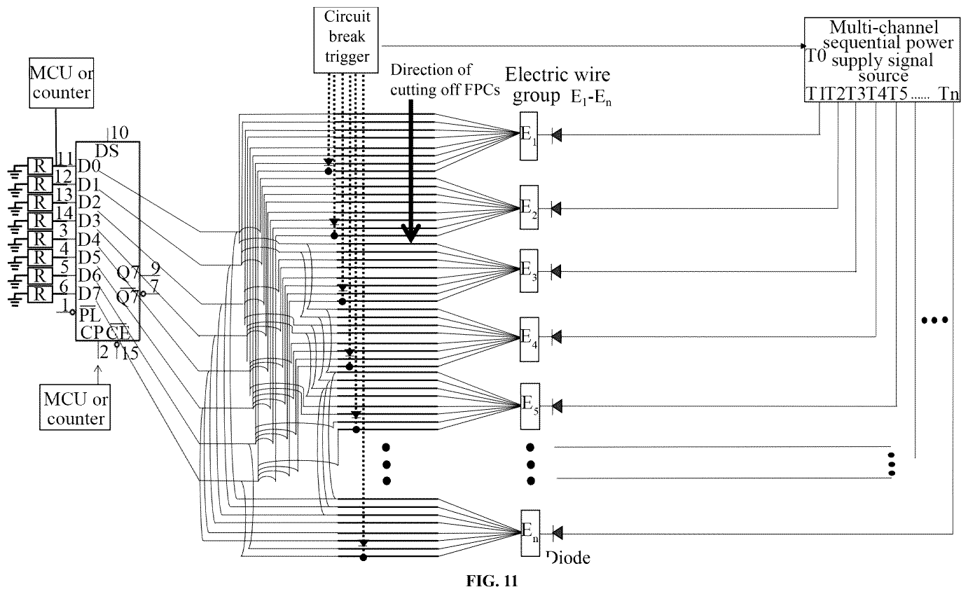

As shown in FIG. 10, in this embodiment, the circuit board 8 includes a parallel-in-to-serial-out chip, an electric wire group E1, an electric wire group E2, an electric wire group E3, an electric wire group E4, an electric wire group E5, an electric wire group E6, an electric wire group E7, . . . , and an electric wire group En. Pins D0, D1, D2, D3, D4, D5, D6 and D7 of the parallel-in-to-serial-out chip are electrically connected to the electric wire groups E1, E2, E3, E4, E5, E6, E7, . . . , and En through the FPCs, respectively. The pin D7 is electrically connected to the downstream of a cutting breakpoint at the lowermost FPC to respective electric wire groups through respective diodes.

In this embodiment, a flip-flop is electrically connected to the downstream of the cutting breakpoint of the FPC at the lowermost FPC to each of the electric wire groups E2, E3, E4, E5, E6, E7 . . . , and En. The electric wire group E1 is electrically connected to a conductive rod, and the electric wire groups E2, E3, E4, E5, E6, E7 and En are connected to a power supply source through the flip-flops and the diodes, respectively.

The circuit board further includes an MCU, or a counter. The MCU or counter is electrically connected to the parallel-in-to-serial-out chip, and the parallel-in-to-serial-out chip is electrically connected to a pulse generator.

In this embodiment, each of the pins D0, D1, D2, D3, D4, D5, D6 and D7 of the parallel-in-to-serial-out chip is electrically connected to a pull-down resistor. One end of each pull-down resistor is electrically connected to corresponding one of the pins D0, D1, D2, D3, D4, D5, D6 and D7 of the parallel-in-to-serial-out chip, and the other end of each pull-down resistor is grounded.

In this embodiment, an operation principle of the circuit board is specifically as follows:

After the conductive rod is in contact with a power supply, the electric wire group is switch on/off using a logic gate circuit. Specifically, when the conductive rod is in contact with a circuit switch, a circuit is started and become conducting, the electric wire group E1 is powered on, all circuits of the electric wire group E1 are switched on, so that voltages are identified and recorded as a high level by the parallel-in-to-serial-out chip. When the FPCs are cut off in sequence, the voltages of the corresponding cut-off circuits turn out to become a low level.

When an eighth circuit of the electric wire group E1 is cut off, a falling edge-triggered flip-flop is started to output the high voltage level. In this case, the electric wire group E2 is switched on, and eight circuits, which are connected to the parallel-in-to-serial-out chip, for the electric wire group E1 are reused, and a working principle of cutting off the FPCs is the same as that of the electric wire group E1. In this case, the electric wire groups E1 and E2 are both at a high level at the upstream of a breakpoint of the FPCs, but at the downstream of the breakpoint of the FPCs, the electric wire group E1 is at a low level and does not cause any interference to the pins of the parallel-in-to-serial-out chip, while the electric wire group E2 is at a low level in a disconnected area, and remained at a high level in an unbroken area. The electric wire groups E3 to En are not switched on, and thus are all at the low level and do not cause any interference to the pins of the parallel-in-to-serial-out chip. When an eighth FPC to the electric wire group E2 is cut off, the electric wire group E3 is started to be powered on.

A pulse signal generated by the pulse generator is injected into the parallel-in-to-serial-out chip to generate 8-bit serial output signal which represents level states, i.e. high or low, of downstream of the corresponding electric wire groups.

The pin D0 of the parallel-in-to-serial-out chip is connected to a count-up counter. When the electric wire group E1 is not powered on, the pin D0 of the parallel-in-to-serial-out chip shows a low level, when a first FPC is switched on and connected to a power supply, the pin D0 of the parallel-in-to-serial-out chip shows a high level, and when the first FPC is cut off, the low level is detected at the pin D0 of the parallel-in-to-serial-out, thus forming a complete pulse consisting of a rising edge signal and a falling edge signal. The count-up counter is incrementally added by 1. A similar situation, from the electric wire group being not powered on to cutting off first circuit, as that of the first circuit to the electric wire group E1 occurs on the first circuit to the second electric wire group. The count-up counter is incrementally added by 1 again. The similar operation is repeated on respective electric wire groups till the electric wire group En. Every time the first circuit to the group is switched on and then cut off, a numerical value of the counter is used to infer which of the electric wire groups the operation is entering. By combining the parallel-in-to-serial-out chip and the count-up counter, the detection of sequential on-off states of infinite circuits can be obtained, so as to compute how many circuits are cut off and obtain the displacement amount of the non-conducting cutter at present, and in turn calculate a remaining accurate distance of the non-conducting cutter relative to the wear critical point and a wear speed of the non-conducting cutter.

Signals output by the parallel-in-to-serial-out chip and the counter are processed by the MCU, and then transmitted to a screen for display, or be directly transmitted out by a wireless signal transmitter such as blue tooth, WiFi, or directly drive a laser source or a light-emitting diode to be directly transmitted to a central control system via an optical fiber for display.

### Embodiment 6

As shown in FIG. 11, in this embodiment, the circuit board 8 includes a multi-channel sequential power supply signal source, a circuit break trigger, a parallel-in-to-serial-out chip, an electric wire group E1, an electric wire group E2, an electric wire group E3, an electric wire group E4, an electric wire group E5, an electric wire group E6, an electric wire group E7, . . . , and an electric wire group En. Pins D0, D1, D2, D3, D4, D5, D6 and D7 of the parallel-in-to-serial-out chip are electrically connected to the electric wire groups E1, E2, E3, E4, E5, E6, E7, . . . , En through the FPCs, respectively.

In this embodiment, the circuit break trigger is electrically connected to the downstream of the cutting breakpoint of the FPCs at the lowermost flexible printed circuit to each of the electric wire groups E1, E2, E3, E4, E5, E6, E7 . . . , and En through a diode. A pin T0 of the multi-channel sequential power supply signal source is electrically connected to the circuit break trigger. The electric wire groups E1, E2, E3, E4, E5, E6, E7, . . . , and En are connected to pins T1, T2, T3, T4, T5, T6, T7, . . . , and Tn on the multi-channel sequential power supply signal source through the diodes, respectively.

The circuit board further comprises an MCU, or a counter. The MCU or the counter is electrically connected to the parallel-in-to-serial-out chip, and the parallel-in-to-serial-out chip is electrically connected to a pulse generator.

In this embodiment, each of the pins D0, D1, D2, D3, D4, D5, D6 and D7 of the parallel-in-to-serial-out chip is electrically connected to a pull-down resistor; and one end of each pull-down resistor is electrically connected to corresponding one of the pins D0, D1, D2, D3, D4, D5, D6 and D7 of the parallel-in-to-serial-out chip, and the other end of each pull-down resistor is grounded.

In this embodiment, an operation principle of the circuit board is specifically as follows:

When the multi-channel power supply signal source is started, the pin T1 transmits a voltage high level signal into the electric wire group E1, such that all circuits in the electric wire group E1 are switched on, and a high level is recorded by the parallel-in-to-serial-out chip. When the FPCs are cut off in sequence, the corresponding cut-off circuits are all converted to be at a low level.

When an eighth circuit in the electric wire group E1 is cut off, the circuit break trigger is started to output a pulse signal to a pin T0 of the multi-channel sequential power supply signal source, and the output high level signal is switched by the multi-channel sequential power supply signal source to the pin T2, thus switching on the electric wire group E2. Eight circuits, which are connected to the parallel-in-to-serial-out chip, for the electric wire group E1 are reused, and an operation principle of cutting off the FPC is the same as that of the electric wire group E1. In this time, except for the electric wire group E2, the rest electric wire groups are not switched on, and thus are all at the low level and do not cause any interference to the pins of the parallel-in-to-serial-out chip. When an eighth FPC of the electric wire group E2 is cut off, the electric wire group E3 is started to be powered on.

A pulse signal generated by the pulse generator is injected into the parallel-in-to-serial-out chip to generate 8-bit signal pulse train which represents voltage level states, i.e. high or low, of downstream of the corresponding electric wire groups.

The pin D0 of the parallel-in-to-serial-out chip is connected to a count-up counter. When the electric wire group E1 is not powered on, the pin D0 of the parallel-in-to-serial-out chip shows a low level, when a first FPC conducts a high voltage level signal, the pin D0 of the parallel-in-to-serial-out chip shows a high level, and when the first wire of the FPC is cut off, the low level is detected at the pin D0 of the parallel-in-to-serial-out, thus forming a complete pulse consisting of a rising edge signal and a falling edge signal. The count-up counter is incrementally added by 1. A similar situation, from the second group being not powered on to the first circuit being cut off, as that of the first circuit of the electric wire group E1 occurs on that first circuit of the second group. In the case, the count-up counter is incrementally added by 1 again. The similar operation is repeated on respective electric wire groups till the electric wire group En. The first circuit of the group is switched on and then cut off at each time, and a numerical value of the counter is used to infer which of electric wire groups the operation is entering. By combining the parallel-in-to-serial-out chip and the count-up counter, the detection of sequential on-off states of infinite circuits can be obtained, so as to compute how many circuits are cut off and obtain the displacement amount of the non-conducting cutter at present, and calculate a remaining accurate distance of the non-conducting cutter relative to the wear critical point and a wear speed of the non-conducting cutter.

Signals output by the parallel-in-to-serial-out chip and the counter are processed by the MCU, and then transmitted to a screen for display, or be directly transmitted out by a wireless signal transmitter, or directly drive a laser source or a light-emitting diode to be directly transmitted to a central control system via an optical fiber for display.

### Embodiment 7

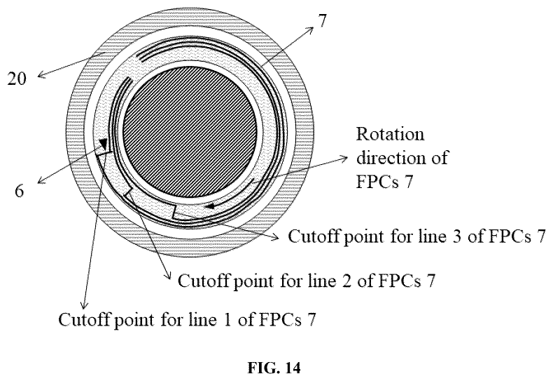

FIG. 13 shows an angular displacement and angular speed detection device in one embodiment. The annular FPCs 7 are attached against the bottom surface of the head of the bolt 26. The serrated teeth 20, and corrugated strip 21 arranged in one-to-one correspondence with the serrated teeth 20, are arranged in an annular pattern to surround the annular FPCs 7. The corrugated strip 21 is arranged on a base board 27 around an opening of a threaded hole receiving a screw of the bolt. When the bolt 26 is rotated with respect to a base board 27 due to an external vibration and is thus loosened, the cutter 6 fixedly located next to the threaded hole of the base board 27 cuts off the FPCs 7 in order. The serrated teeth 20 mesh with the corrugated strip 21 each other between the bolt 26 and the base board 27. The data of the angular displacement and angular speed of bolt loosened can be real-time transmitted using integrated circuits 28 electrically connected to the FPCs 7 and a bidirectional wireless transceiver 29. Both the integrated circuits 28 and the bidirectional wireless transceiver 29 are mounted on the top surface of the head of the bolt 26 and are electrically connected to each other and FPCs 7. In one embodiment, the bidirectional wireless transceiver 29 is also used to couple the electromagnetic waves from an external (charging) device (not shown in FIG. 13) to supply electricity for the integrated circuits 28 and a wireless transceiver 29. The signals, carrying circuit on-off information of FPCs 7, are sent out by the wireless transceiver 29 and further picked-up by the wireless receiver on the external device for further analysis.

FIG. 14 further shows a position relationship among the serrated teeth 20, the FPCs 7 and the cutter 6, of the angular displacement and angular speed detection device, viewed from the bottom of the head of the bolt 26. As the bolt 26 is rotated with respect to the base board 27, the cutter 6 cuts off the FPCs 7 in order, e.g., cutting off line 1, line 2, line 3 and so on.

In one embodiment, the external device may be the high speed train. Bolts of the rails can be detected using the detection device of Embodiment 7. The signals, carrying circuit on-off information of FPCs 7, are then sent out by the wireless transceiver 29 and further picked-up by the wireless receiver on the high speed train for analyzing and alerting the loosening situation of bolts on rails.

Finally, it should be noted that the above embodiments are only used to illustrate the technical solution of the present disclosure rather than limiting. Although the present disclosure has been described in detail with reference to the foregoing embodiments, those of ordinary skill in the art should understand that it is still possible to modify the technical solution described in the foregoing embodiments, or to replace some technical features with equivalents. However, these modifications or substitutions do not make the essence of the corresponding technical solutions deviate from the spirit and scope of the technical solutions of various embodiments of the present disclosure.

What is claimed is:

1. A wear and displacement detection device, comprising a unidirectional push-forward mechanical structure, wherein one end of the unidirectional push-forward mechanical structure is provided with a non-conducting cutter, flexible printed circuits (FPCs) are arranged below the non-conducting cutter, and the FPCs are electrically connected to a circuit board; and cutoff signals of the FPCs are obtained through the circuit board when individual FPCs are cut off in order, thus obtaining a wear condition and a wear speed of a mechanical structure based on a displacement amount.

2. The wear and displacement detection device according to claim 1, wherein the unidirectional push-forward mechanical structure comprises an outer sleeve, and a signal emitting unit; a baffle is arranged at a lower-middle position of the outer sleeve, an inner sleeve is arranged at an upper portion of the outer sleeve, and the inner sleeve is located above the baffle; a guide pillar is arranged on an inner side of an upper side surface of the outer sleeve, and in match with an outer wall of the inner sleeve to achieve limiting;
a boss is arranged at a middle position of an upper end surface of the inner sleeve, one end of the boss is located outside the outer sleeve, the non-conducting cutter is arranged at an other end of the boss, and one end of the non-conducting cutter is mounted at a middle position of the boss; the FPCs are arranged at an other end of the non-conducting cutter, the circuit board is mounted on the baffle, and a power supply unit is arranged below the baffle, and configured to supply power to the circuit board; and
the circuit board is electrically connected to the signal emitting unit, and the signal emitting unit is configured to convert an electric signal into a wireless signal or an optical signal and transmit the wireless signal or the optical signal via an optical fiber.

3. The wear and displacement detection device according to claim 2, wherein one side, close to the outer wall of the inner sleeve, of the guide pillar is provided with limiting teeth, the outer wall of the inner sleeve is provided with barb teeth, and the barb teeth are meshed with the limiting teeth to achieve limiting;
one side of the circuit board is provided with a conductive communicating slot;
a conductive rod is arranged in the inner sleeve, one end of the conductive rod is fixedly connected to the inner sleeve, an other end of the conductive rod is in match with the conductive communicating slot, and in an initial state, the conductive rod is located above the circuit board, and gradually enters the conductive communicating slot with downward movement of the conductive rod;
the other end of the non-conducting cutter is provided with a plurality of rows of metal tubes, and both ends of the metal tubes are connected to wires on both sides of the metal tubes, respectively.

4. The wear and displacement detection device according to claim 2, wherein the circuit board comprises a first parallel-in-to-serial-out chip, a second parallel-in-to-serial-out chip, a first resistor, a second resistor, a third resistor, a fourth resistor, a fifth resistor, a sixth resistor, a seventh resistor, an eighth resistor, a first electric wire group, a second electric wire group, a third electric wire group, a fourth electric wire group, a fifth electric wire group, a sixth electric wire group, a seventh electric wire group, and an eighth electric wire group; a pin D0 on the first parallel-in-to-serial-out chip is electrically connected to the first resistor, a pin D1 on the first parallel-in-to-serial-out chip is electrically connected to the second resistor, a pin D2 on the first parallel-in-to-serial-out chip is electrically connected to the third resistor, a pin D3 on the first parallel-in-to-serial-out chip is electrically connected to the fourth resistor, a pin D4 on the first parallel-in-to-serial-out chip is electrically connected to the fifth resistor, a pin D5 on the first parallel-in-to-serial-out chip is electrically connected to the sixth resistor, a pin D6 on the first parallel-in-to-serial-out chip is electrically connected to the seventh resistor, and a pin D7 on the first parallel-in-to-serial-out chip is electrically connected to the eighth resistor; the first resistor, the second resistor, the third resistor, the fourth resistor, the fifth resistor, the sixth resistor, the seventh resistor and the eighth resistor are electrically connected to the first electric wire group, the second electric wire group, the third electric wire group, the fourth electric wire group, the fifth electric wire group, the sixth electric wire group, the seventh electric wire group and the eighth electric wire group through the FPCs, respectively;
a pin D0 on the second parallel-in-to-serial-out chip is electrically connected to the first electric wire group, a pin D1 on the second parallel-in-to-serial-out chip is electrically connected to the second electric wire group, a pin D2 on the second parallel-in-to-serial-out chip is electrically connected to the third electric wire group, a pin D3 on the second parallel-in-to-serial-out chip is electrically connected to the fourth electric wire group, a pin D4 on the second parallel-in-to-serial-out chip is electrically connected to the fifth electric wire group, a pin D5 on the second parallel-in-to-serial-out chip is electrically connected to the sixth electric wire group, a pin D6 on the second parallel-in-to-serial-out chip is electrically connected to the seventh electric wire group, a pin D7 on the second parallel-in-to-serial-out chip is electrically connected to the eighth electric wire group, and a pin Q7 on the second parallel-in-to-serial-out chip is electrically connected to a pin DS on the first parallel-in-to-serial-out chip.

5. The wear and displacement detection device according to claim 4, wherein a flip-flop is arranged at a lowermost FPC to each of the second electric wire group, the third electric wire group, the fourth electric wire group, the fifth electric wire group, the sixth electric wire group, the seventh electric wire group and the eighth electric wire group; and the first electric wire group is electrically connected to the conductive rod; and the second electric wire group, the third electric wire group, the fourth electric wire group, the fifth electric wire group, the sixth electric wire group, the seventh electric wire group and the eighth electric wire group are connected to the conductive rod through the flip-flops, respectively.

6. The wear and displacement detection device according to claim 5, wherein diodes are arranged at connections of the second electric wire group, the third electric wire group, the fourth electric wire group, the fifth electric wire group, the sixth electric wire group, the seventh electric wire group and the eighth electric wire group with the first resistor, the second resistor, the third resistor, the fourth resistor, the fifth resistor, the sixth resistor, the seventh resistor and the eighth resistor;
the circuit board further comprises a microprocessor control unit (MCU), and a display screen; the MCU is electrically connected to the first parallel-in-to-serial-out chip and the display screen, and configured to acquire data on the first parallel-in-to-serial-out chip; and the display screen is configured to display the data acquired by the MCU; and
a pulse generator is electrically connected to the first parallel-in-to-serial-out chip.

7. The wear and displacement detection device according to claim 6, wherein an operation principle of the circuit board is as follows:
when the conductive rod is in contact with a circuit switch, a circuit is started and become conducting, the first electric wire group is powered on, the first resistor, the second resistor, circuits comprising the third resistor, the fourth resistor, the fifth resistor, the sixth resistor, the seventh resistor and the eighth resistor are all switched on so that voltages are identified and recorded as a high level by the first parallel-in-to-serial-out chip; when the FPCs are cut off, voltages of circuits in front of the conducted circuit turn out to become a low level;
when an eighth circuit to the first electric wire group is cut off, a falling edge-triggered flip-flop is started to operate, the second electric wire group is switched on, and eight resistors including the first resistor, the second resistor, the third resistor, the fourth resistor, the fifth resistor, the sixth resistor, the seventh resistor and the eighth resistor, connected to the first electric wire group are reused, an operation principle of cutting off the FPCs is the same as an operation principle of the first electric wire group; the first electric wire group and the second electric wire group are both at the high level at upstream of the FPCs, but at downstream of the FPCs, the first electric wire group is at the low level, the second electric wire group is at the low level in a disconnected area and remained at the high level in an unbroken area; the third electric wire group, the fourth electric wire group and the fifth electric wire group are not switched on, and thus all are at the low level; and when an eighth FPC wire to the second electric wire group is cut off, the third electric wire group is started to be powered on;
high-low level states of the first electric wire group, the second electric wire group, the third electric wire group, the fourth electric wire group, the fifth electric wire group, the sixth electric wire group, the seventh electric wire group and the eighth electric wire group at upstream are transmitted to the second parallel-in-to-serial-out chip, and then a serial signal is merged into the first parallel-in-to-serial-out chip, the merged signal pulse train has a total of 16 bits, in which the first eight bits indicate on/off state for eight individual circuits belonging to a certain electric wire group, and an other eight bits are on-off states of the first electric wire group, the second electric wire group, the third electric wire group, the fourth electric wire group and the fifth electric wire group, an exact number of cut-off circuits and the displacement amount of the non-conducting cutter are calculated based on the merged signal pulse train, and a remaining accurate distance of the non-conducting cutter relative to a wear critical point and the wear velocity of the non-conducting cutter are calculated;
a signal output by the first parallel-in-to-serial-out chip is processed by the MCU, and then transmitted to the display screen for display, or be directly transmitted out by a wireless signal transmitter, or directly drive a laser source or a light-emitting diode to be directly transmitted to a central control system via an optical fiber for display.

8. The wear and displacement detection device according to claim 1, wherein the unidirectional push-forward mechanical structure comprises a sleeve, the circuit board is arranged at one end of the sleeve, and an other end of the sleeve is provided with a push rod base; one end of the push rod base is provided with a push rod, and the non-conducting cutter is arranged at an other end of the push rod base; a fixing groove is formed in an inner side of the sleeve, the non-conducting cutter is located at one end of the fixing groove, and the FPCs are arranged at an other end of the fixing groove; and the FPCs are electrically connected to the circuit board and located on a moving path of a cutting edge of the non-conducting cutter, and a side wall of the sleeve is in match with the push rod base through a limiting mechanism.

9. The wear and displacement detection device according to claim 8, wherein the limiting mechanism comprises multiple groups of spring pins, and multiple groups of oblique dentations corresponding to the spring pins; each group of spring pins is arranged on the side wall of the sleeve in an axial direction, and each group of oblique dentations are arranged on an outer side wall of the push rod base in the axial direction; the spring pin is in match with the oblique dentation in a clamping manner, when the oblique dentation passes through the spring pin, the spring pin bounces up, and after passing through the spring spin, the spring pin is reset to catch the oblique dentation.

10. The wear and displacement detection device according to claim 8, wherein the limiting mechanism comprises serrated teeth, and corrugated strips arranged in one-to-one correspondence with the serrated teeth, wherein a plurality of groups of serrated teeth are provided and circumferentially distributed on an inner side wall of the sleeve; each group of serrated teeth is arranged on the side wall of the sleeve in the axial direction, and adjacent groups of serrated teeth are staggered according to a set phase difference; and each group of corrugated strips is arranged on the outer side wall of the push rod base in the axial direction, and the serrated teeth are clamped with the corrugated strips.

11. The wear and displacement detection device according to claim 10, wherein the FPCs are electric wires arranged at a specific period, and the FPCs satisfy a phase-matching condition with an effective period of the limiting mechanism, wherein the effective period is equal to an actual displacement of whole multiple groups of serrated teeth upon traveling one step or experiencing a meshing.

12. The wear and displacement detection device according to claim 8, wherein the circuit board comprises a parallel-in-to-serial-out chip, a first electric wire group, a second electric wire group, a third electric wire group, a fourth electric wire group, a fifth electric wire group, a sixth electric wire group, a seventh electric wire group, . . . , and an n^{th} electric wire group; a pin D0, a pin D1, a pin D2, a pin D3, a pin D4, a pin D5, a pin D6 and a pin D7 of the parallel-in-to-serial-out chip are electrically connected to the first electric wire group, the second electric wire group, the third electric wire group, the fourth electric wire group, the fifth electric wire group, the sixth electric wire group, the seventh electric wire group, . . . , and the n^{th} electric wire group through the FPCs, respectively; and the pin D7 is electrically connected to downstream of a cutting breakpoint at a lowermost FPC to respective electric wire groups through respective diodes.

13. The wear and displacement detection device according to claim 12, wherein a flip-flop is electrically connected to downstream of the cutting breakpoint of the FPC at the lowermost FPC to each of the second electric wire group, the third electric wire group, the fourth electric wire group, the fifth electric wire group, the sixth electric wire group, the seventh electric wire group, . . . , and the n^{th} electric wire group; the first electric wire group is electrically connected to a conductive rod, and the second electric wire group, the third electric wire group, the fourth electric wire group, the fifth electric wire group, the sixth electric wire group, the seventh electric wire group to the n^{th} electric wire group are connected to a power supply through the flip-flops and the diodes, respectively;
the circuit board further comprises an MCU or a counter; the MCU or the counter is electrically connected to the parallel-in-to-serial-out chip, and the parallel-in-to-serial-out chip is electrically connected to a pulse generator; and
each of the pin D0, the pin D1, the pin D2, the pin D3, the pin D4, the pin D5, the pin D6 and the pin D7 of the parallel-in-to-serial-out chip is electrically connected to a pull-down resistor; and one end of each pull-down resistor is electrically connected to corresponding one of the pin D0, the pin D1, the pin D2, the pin D3, the pin D4, the pin D5, the pin D6 and the pin D7 of the parallel-in-to-serial-out chip, and an other end of each pull-down resistor is grounded.

14. The wear and displacement detection device according to claim 13, wherein an operation principle of the circuit board is as follows:
when the conductive rod is in contact with a circuit switch, a circuit is started and become conducting, the first electric wire group is powered on, all circuits of the first electric wire group are switched on so that voltages are identified and recorded as a high level by the parallel-in-to-serial-out chip; when the FPCs are cut off in sequence, voltages of corresponding cut-off circuits turn out to become a low level;
when an eighth circuit to the first electric wire group is cut off, a falling edge-triggered flip-flop is started to output the high level, while the second electric wire group is switched on, and eight circuits, which are connected to the parallel-in-to-serial-out chip, of the first electric wire group are reused, and an operation principle of cutting off the FPCs is the same as an operation principle of the first electric wire group; at the moment, the first electric wire group and the second electric wire group are both at the high level at upstream of a breakpoint of the FPCs, but at downstream of the breakpoint of the FPCs, the first electric wire group is at the low level and does not cause any interference to the pins of the parallel-in-to-serial-out chip, while the second electric wire group is at the low level in a disconnected area, and remained at a high level in an unbroken area; the third electric wire group to the n^{th} electric wire group are not switched on, and thus are all at the low level and do not cause any interference to the pins of the parallel-in-to-serial-out chip; and when the eighth FPC to the second electric wire group is cut off, the third electric wire group is started to be powered on;
a pulse signal generated by the pulse generator is injected into the parallel-in-to-serial-out chip to generate 8-bit serial output signal for representing high-low level states of downstream of the corresponding electric wire groups;
the pin D0 of the parallel-in-to-serial-out chip is connected to a count-up counter; when the first electric wire group is not powered on, the pin D0 of the parallel-in-to-serial-out chip shows the low level, when a first FPC wire is switched on and connected to a power supply, the pin D0 of the parallel-in-to-serial-out chip shows the high level, and when the first FPC wire is cut off, the low level is detected at the pin D0 of the parallel-in-to-serial-out, thus forming a complete pulse consisting of a rising edge signal and a falling edge signal, and the count-up counter is incrementally added by 1; a situation similar to the first circuit to the first electric wire group is formed from a situation that a first circuit of the second group is not powered on to a situation that the first circuit is cut off, the count-up counter is incrementally added by 1 again; and then similar operation is repeated till starting of the n^{th} electric wire group; every time a first circuit of the group is switched on and then cut off, a numerical value of the counter is used to infer that the operation enters an n^{th} electric wire group; after merging the parallel-in-to-serial-out chip and the count-up counter, detection of sequential on-off states of infinite circuits is obtained, a number of cut-off circuits is calculated and the displacement amount of the non-conducting cutter is obtained based on the detection, and a remaining accurate distance of the non-conducting cutter relative to a wear critical point and the wear speed of the non-conducting cutter are calculated; and
signals output by the parallel-in-to-serial-out chip and the counter are processed by the MCU, and then transmitted to a screen for display, or be directly transmitted out by a wireless signal transmitter, or directly drive a laser source or a light-emitting diode to be directly transmitted to a central control system via an optical fiber for display.

15. The wear and displacement detection device according to claim 8, wherein the circuit board comprises a multi-channel sequential power supply signal source, a circuit break trigger, a parallel-in-to-serial-out chip, a first electric wire group, a second electric wire group, a third electric wire group, a fourth electric wire group, a fifth electric wire group, a sixth electric wire group, a seventh electric wire group, . . . , and an n^{th} electric wire group; a pin D0, a pin D1, a pin D2, a pin D3, a pin D4, a pin D5, a pin D6 and a pin D7 of the parallel-in-to-serial-out chip are electrically connected to the first electric wire group, the second electric wire group, the third electric wire group, the fourth electric wire group, the fifth electric wire group, the sixth electric wire group, the seventh electric wire group, . . . , the n^{th} electric wire group through the FPCs, respectively.

16. The wear and displacement detection device according to claim 15, wherein the circuit break trigger is electrically connected to downstream of a cutting breakpoint of the FPCs at a lowermost FPC to each of the first electric wire group, the second electric wire group, the third electric wire group, the fourth electric wire group, the fifth electric wire group, the sixth electric wire group, the seventh electric wire group, . . . , and the n^{th} electric wire group through a diode, and a pin T0 of the multi-channel sequential power supply signal source is electrically connected to the circuit break trigger; the first electric wire group, the second electric wire group, the third electric wire group, the fourth electric wire group, the fifth electric wire group, the sixth electric wire group, the seventh electric wire group, . . . , and the n^{th} electric wire group are connected to a pin T1, a pin T2, a pin T3, a pin T4, a pin T5, a pin T6, a pin T7, . .. , and a pin Tn on the multi-channel sequential power supply signal source through diodes, respectively;
the circuit board further comprises an MCU, or a counter; the MCU or the counter is electrically connected to the parallel-in-to-serial-out chip, and the parallel-in-to-serial-out chip is electrically connected to a pulse generator.

17. The wear and displacement detection device according to claim 16, wherein each of the pin D0, the pin D1, the pin D2, the pin D3, the pin D4, the pin D5, the pin D6 and the pin D7 of the parallel-in-to-serial-out chip is electrically connected to a pull-down resistor; and one end of each pull-down resistor is electrically connected to corresponding one of the pin D0, the pin D1, the pin D2, the pin D3, the pin D4, the pin D5, the pin D6 and the pin D7 of the parallel-in-to-serial-out chip, and an other end of each pull-down resistor is grounded.

18. The wear and displacement detection device according to claim 17, wherein an operation principle of the circuit board is as follows:
when the multi-channel power supply signal source is started, the pin T1 transmits a high voltage level signal into the first electric wire group, such that all circuits in the first electric wire group are switched on, and a high level is recorded by the parallel-in-to-serial-out chip; when the FPCs are cut off in sequence, corresponding cut-off circuits are all converted to be at a low level;
when an eighth circuit of the first electric wire group is cut off, the circuit break trigger is started to output a pulse signal to the pin T0 of the multi-channel sequential power supply signal source, an output high level signal is switched by the multi-channel sequential power supply signal source to the pin T2, thus switching on the second electric wire group; eight circuits, which are connected to the parallel-in-to-serial-out chip, of the first electric wire group are reused, and an operation principle of cutting off the FPCs is the same as that of the first electric wire group; at the moment, except for the second electric wire group, rest of electric wire groups are not switched on, and thus are all at the low level and do not cause any interference to the pins of the parallel-in-to-serial-out chip; when an eighth FPC to the second electric wire group is cut off, the third electric wire group is started to be powered on;
a pulse signal generated by the pulse generator is injected into the parallel-in-to-serial-out chip to generate 8-bit signal pulse train for representing high-low level states of downstream of corresponding electric wire groups;
the pin D0 of the parallel-in-to-serial-out chip is connected to a count-up counter; when the first electric wire group is not powered on, the pin D0 of the parallel-in-to-serial-out chip shows the low level, when a first FPC wire conducts a high voltage level signal, the pin D0 of the parallel-in-to-serial-out chip shows the high level, and after the first FPC wire is cut off, the low level is detected at the pin D0 of the parallel-in-to-serial-out, thus forming a complete pulse consisting of a rising edge signal and a falling edge signal and the count-up counter is incrementally added by 1; a situation similar to that of the first circuit of the first electric wire group is formed from a situation that a first circuit of the second group is not powered on to a situation that the first circuit of the second group is cut off, and the count-up counter is incrementally added by 1 again, and then the similar operation is repeated till starting of the n^{th} electric wire group, every time a first circuit of the group is switched on and then cut off, and a numerical value of the counter is used to infer that an operation enters the n^{th} electric wire group; after merging the parallel-in-to-serial-out chip and the count-up counter, detection of sequential on-off states of infinite circuits is obtained, a number of cut-off circuits is calculated and the displacement amount of the non-conducting cutter is obtained based on the detection, and a remaining accurate distance of the non-conducting cutter relative to a wear critical point and the wear speed of the non-conducting cutter are calculated; and
signals output by the parallel-in-to-serial-out chip and the counter are processed by the MCU, and then transmitted to a screen for display, or be directly transmitted out by a wireless signal transmitter, or directly drive a laser source or a light-emitting diode to be directly transmitted to a central control system via an optical fiber for display.

19. A wear and displacement detection device, comprising: a non-conducting cutter, flexible printed circuits (FPCs), a circuit board and a limiting mechanism, wherein
the circuit board is mounted on a side surface of a head of a bolt to be detected and another side surface of the head of the bolt is provided with a screw inserted into a threaded hole in a base board;
the FPCs are arranged on the another side surface of the head around the screw in a circumferential direction of the screw, and the FPCs are electrically connected to the circuit board; and
the non-conducting cutter is positioned adjacent to the threaded hole and fixed to a side surface of the base board that is provided with the threaded hole, and located on a moving path of the FPCs, the bolt is in match with the base board through the limiting mechanism.

20. The wear and displacement device according to claim 19, wherein the limiting mechanism comprises serrated teeth and a corrugated strip arranged in correspondence with the serrated teeth, wherein the serrated teeth are arranged on the another side surface of the head around the FPCs in the circumferential direction of the screw and positioned to be further away from the screw than the FPCs in a radial direction of the screw, and the corrugated strip is arranged on side surface of the base board around an opening of the threaded hole in a circumferential direction of the threaded hole, the serrated teeth are meshed with the corrugated strip.
